(19) United States
(12) Patent Application Publication
(10) Pub. No.: US 2016/0153866 A1
(43) Pub. Date: Jun. 2, 2016

(54) METHOD TO CONTROL END SPEED OF A VEHICLE IN A CRASH TEST AFTER A PROPULSION AND COAST DOWN PHASE

(71) Applicants: Roland Vander Straeten, Guelph (CA); Dan Wu, Windsor (CA)

(72) Inventors: Roland Vander Straeten, Guelph (CA); Dan Wu, Windsor (CA)

(73) Assignee: Anemoi Group Inc., Flamborough (CA)

(21) Appl. No.: 14/557,950

(22) Filed: Dec. 2, 2014

(51) Int. Cl. G01M 17/007

(52) U.S. Cl. CPC G01M 17/0078

(57) ABSTRACT

In the crash test an object having a known mass is propelled along a propulsion path, continuously taking measurements of acceleration, velocity and force allowing a control system, in real time, to calculate the coefficients aᵢ in the expression (a₀+a₁v+a₂v²). The operator selects a velocity v_{c} at which the object should be traveling when the object strikes the barrier. Using the selected velocity v_{c} and values determined for a₀, a₁ and a₂ an operator can determine a release velocity vᵣ where the vehicle can be released from a release point and then coast and decelerating to the velocity v_{c} when the vehicle hits the crash barrier.

### FIELD OF INVENTION

The invention relates to vehicle crash tests and impact testing of vehicles and other objects.

### BACKGROUND OF THE INVENTION

Manufacturers and others test cars, vans and trucks to determine the amount and type of damages that occurs when the vehicle strikes a barrier at a known speed. These tests are also used to evaluate safety devices such as seat belts and air bags. Crash testing has also been done using objects other than motor vehicles. In some applications, the vehicle or other object must be propelled in some fashion, released from the propulsion system and after a period of free motion must reach a defined target at a specific speed, within a small tolerance. The vehicle or object may be tested while surrounded by air or water and may travel on a test facility floor as in the example of a car crash test. These surroundings provide resistance forces during the coast down period. To assure that the vehicle or object hits the barrier at the desired speed, one must determine these resistance forces and design the test accordingly.

In many cases the person conducting the test will estimate the resistance forces and adjust the test parameters based upon those estimates. Often the estimates are based upon calibration runs. But conducting a calibration run is time consuming, sometimes is limited to speeds lower than the test speed, and may not be accurate enough if too much time lapses between the calibration and the actual test. Another problem is that the actual propulsion system may not behave as estimated before a test.

Consequently, there is a need for a crash test in which the person conducting the test is able to assure that the vehicle or other object is traveling at the desired speed when the vehicle or other object hits the barrier.

### SUMMARY OF THE INVENTION

I provide a crash test method in which the velocity of the object at the time of the crash is not dependent upon the accuracy of the propulsion system. In the present method the vehicle or object is released from the propulsion system at specific speed and distance as described below which causes the vehicle or object to be traveling at the desired speed when it strikes a crash barrier.

In the crash test an object having a known mass is propelled along a propulsion path, released at a release point and coasts until striking a barrier. The motion of the object along the propulsion path is expressed by the equation M A=F−R=F−(a₀+a₁v+a₂v²) where A is acceleration, F is force, M is mass of the object, R is resistance, v is velocity and a₀, a₁ and a₂ are=constants. The force F is programmable before the test (such as F is controlled to be a constant). From these calculations, and the relationship s=dv/dt, the computer can calculate a relationship v=f₁(s) and can extrapolate (predict) the motion beyond the actual [v,s]

Motion during coasting (where F=0) is expressed by the equation A=dv/dt=−R/M=−(a₀+a₁v+a₂v²)/M and with v=ds/dt can be resolved to an equation v=f₂(s)

The method begins with the operator selecting a velocity v_{c} at which the object should be traveling when the object strikes the barrier, then propelling and accelerating the object along the propulsion path, continuously taking measurements of acceleration, velocity and force allowing the control system, in real time, to calculate (via a regression analysis) the coefficients aᵢ. in the expression (a₀+a₁v+a₂v²). Using the selected velocity v_{c} and values determined for a₀, a₁ and a₂ the computer solves the equation v=f₂(s) with the condition v=v_{c} at s=s_{c} and calculates the intersection point between that curve and the propulsion curve v=f₁(s) and releases the force when the object is traveling at that intersection point so that the object coasts until the object strikes the barrier at the desired velocity v_{c}.

During the coast down, the object's speed reduces due to resistances consisting of friction, fluid mechanic drag, etc. The coast down distance itself is dependent on the location of the point of release.

### BRIEF DESCRIPTION OF THE FIGURES

FIG. 1 is a graph of the speed of an object being tested during the propulsion stage v=f₁(s) and the speed of the object during the coast stage v=f₂(s) of a crash test.

FIG. 2 is a graph of the speed of an object being tested during the propulsion stage and during the coast stage of a crash test conducted as described herein.

FIG. 3 is an enlarged portion of the graph shown in FIG. 2.

FIG. 4 is a side view of a vehicle being tested in accordance with a present preferred embodiment of our method.

### DESCRIPTION OF THE PREFERRED EMBODIMENTS

The basis of the process is the measurement of propulsion force, and the object's acceleration, speed and distance travelled during the propulsion phase, during the actual test, in real time. Propulsion force typically would be measured with a load cell, acceleration with an accelerometer and speed could be measured with an encoder or derived from the accelerometer output. Distance travelled can be derived either from the encoder or the accelerometer output. The applicable equation of motion is:

MA=F−R=F−(a₀+a₁v+a₂v²), (1)

where
A (measured) Acceleration
F (measured) force
M mass of the object
R resistance force
V (measured) speed
During the coast-down phase, where F=0, the equation of motion is

A=dv/dt=−R/M=−(a₀+a₁v+a₂v²)/M (2)

where aᵢ are coefficients to be determined by regression analysis

Once the coefficients have been determined, we can track solutions where F=0, in other words, we can solve the differential/integral equation dv/dt=−(a₀+a₁v+a₂v²)/M and v=ds/dt for ending point v_{c} where ds is the change in distance traveled of time period dt.

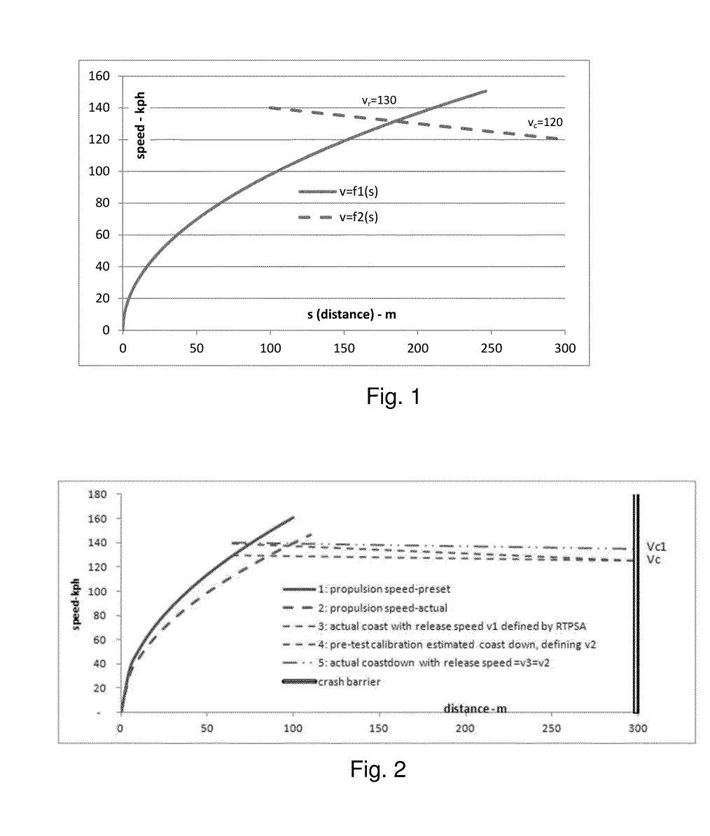

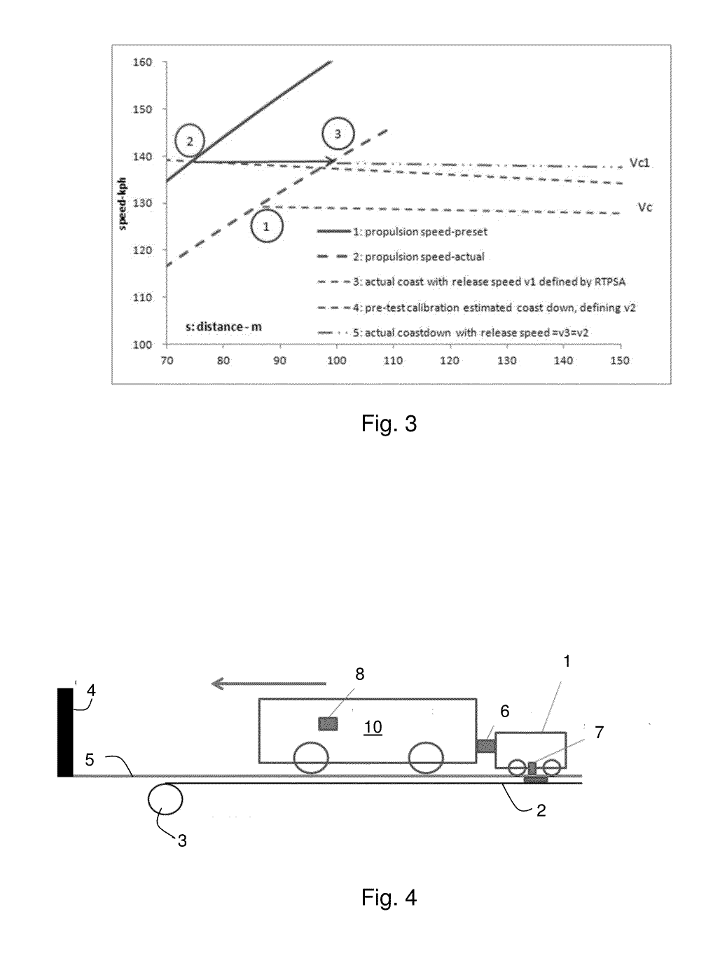

Thus, if the crash speed v_{c} is set and the coefficients are calculated in real time, we can calculate backwards the coast curve which is shown as v=f₂(s) in FIG. 1 and line 3 in FIGS. 2 and 3. Combined with real time measurement and very short extrapolation of the actual performance of the propulsion system, (v=f₁(s) in FIG. 1) we can schedule the release point ([130,180] in FIG. 1 and point 1 in FIG. 3) very accurately, where:

Point 1: s₁, v₁: intersection of actual propulsion performance with coast curve calculated with RTPSA, a regression analysis method;
Point 2: s₂, v₂: intersection of preset propulsion performance with coast curve calculated with pre-test calibration data: v₂ is the pretest calculated value; and
Point 3: s₃, v₃: intersection of actual propulsion performance with coast curve calculated with pre-test calibration data

The advantage of the present method can be seen from FIGS. 2 and 3. Lines 1 and 4 in FIGS. 2 and 3 are pre-test estimates based on estimated propulsion performance and estimated resistance from a calibration test. The results of the calibration test may have determined a release speed v₂. But, since the actual propulsion performance line 2 is different from the pre-test estimated performance line 1, the object would be released at point 3 (with a speed of v₃=v₂), but at a distance s₃ instead of s₂. (Therefore the coast down distance is different from the estimated value). This, combined with a possibly less accurate estimate of the resistance force, results in an actual crash speed v_{c1}, instead of the desired speed v_{c}.

FIGS. 2 and 3 show a predefined target speed equal to v_{c}, obtained via actual propulsion line (2) and an actual coast down with this method, line (3). In this example, the objective of a test could be a target crash speed of 70 kph at a distance of 100 m from the start of the acceleration.

Referring to FIG. 4 in one embodiment of the test a propulsion cart 1 is propelled toward a crash barrier 4 by a cable 2 connected to a drum 3 driven by an electric motor which is not shown. A load cell 6 is integrated in the connection between the cable 2 and the vehicle 10 under test. This vehicle may be a car, truck or van. A speed encoder 7 is provided in the propulsion cart 1 and an accelerometer 8 is provided in the car being tested. A control system having a control computer is provided for operating the propulsion cart and receiving data from the speed encoder, load cell, and accelerometer. While the vehicle 10 is propelled along the track 5, the measurements described above are taken and input into a control computer. The control computer calculates the coefficients a₀, a₁ and a₂ using regression analysis as described. When enough samples are taken (when the control computer determines that there is a convergence of the solutions), the computer calculates the line v=f₂(s) in FIG. 1 and line 3 in FIGS. 2 and 3, starting at v_{c}=70 kph. Also during the propulsion phase, the measurements of speed (v) and distance travelled (s) allow the control computer to generate the v=f₁(s) in FIG. 1 and line 2 in FIGS. 2 and 3, and by extrapolation allow the control system to predict the crossing of lines 2 and 3. The vehicle is not released from the propulsion cart until sufficient measurements have been taken to calculate line 3. Then the operator will know the speed at which the vehicle being tested should be released as well as the release point. Now the operator can complete the test by propelling the test vehicle in a manner to achieve the defied velocity at the release point and there releasing the vehicle. In the example shown in FIG. 3 the propulsion cart and the vehicle being tested are traveling over a flat surface. There may be no mechanical connection between the test vehicle and the propulsion cart or a clamp which is opened when the brakes are applied to the propulsion cart. Consequently, the test vehicle is released when brakes are applied to the propulsion cart.

In one example, a car could be released from the propulsion cart when its speed is measured at 73.5 kph at a distance of 60 m. At that point the propulsion force is zero, and the resistance to the car's motion (rolling friction, aerodynamic drag etc.) will slow the car down to 70 kph over the remaining 40 m. Then the car will strike the barrier at the desired velocity of 70 kph.

Although we have described and illustrated our method of performing a crash test using a cable driven propulsion cart traveling on a rail to push a vehicle being tested, the method is not limited to that situation. This method can be used to test any object that is propelled in any controlled manner.

We claim:

1. A method of performing a crash test in which an object having a known mass is propelled along a propulsion path, released at a release point and coasts until striking a barrier in which motion along the propulsion path is expressed by the equation M A=F−R=F−(a₀+a₁v+a₂v²) where A is acceleration, F is force, M is mass of the object R is resistance, v is velocity and a₀, a₁ and a₂ are constants and motion during coasting (where F=0) is expressed by the equation
A=dv/dt=−R/M=−(a₀+a₁v+a₂v²)/M,
the method comprised of:
propelling and accelerating the object along the propulsion path, continuously taking measurements of acceleration, velocity and force calculating in real time the coefficients aᵢ. in the expression (a₀+a₁v+a₂v²);
selecting a velocity v_{c} at which the object is traveling when the object strikes the barrier;
using the selected velocity v_{c} and values determined for a₀, a₁ and a₂ to solve this equation v=f₂(s) for a velocity vᵣ where the vehicle can be released for coasting and then decelerate to v_{c};
applying a force to the object to propel and accelerate the object along the propulsion path; and
releasing the force when the object is traveling at the velocity vᵣ so that the object coasts until the object strikes the barrier.

2. The method of claim 1 wherein a₀, a₁ and a₂ are calculated using a regression analysis.

3. The method of claim 1 wherein a control computer calculates the coefficients aᵢ. in the expression (a₀+a₁v+a₂v²).

4. The method of claim 1 wherein a propulsion cart propels the object.

5. The method of claim 4 wherein the propulsion cart travels on a rail.

6. The method of claim 1 wherein the object is a vehicle.
